(19) United States
(12) Patent Application Publication
(10) Pub. No.: US 2011/0280008 A1
(43) Pub. Date: Nov. 17, 2011

(54) Floating Candle with Removable Light Emitter

(76) Inventor: Mehrdad Bakian, Newport Beach, CA (US)

(21) Appl. No.: 12/779,861

(22) Filed: May 13, 2010

(51) Int. Cl. F21V 33/00; F21V 35/00; F21V 21/00

(52) U.S. Cl. 362/161; 362/382; 362/392; 362/253

(57) ABSTRACT

A light emitting system has a base portion and a removable portion. The base portion has a coupling for receiving the removable portion. The removable portion has a light emitter, such as a wick, candle, or light emitting diode. The base portion has at least some wax. The light emitting system is shaped to resemble an object, such as a flower or butterfly. The light emitting system is configured to float in a liquid and can further contain electrical components, such as an audio speaker, microphone, receiver, or control unit.

### FIELD OF THE INVENTION

The field of the invention is floating candles.

### BACKGROUND

Floating candles are well known in the art. However, such floating candles known to Applicant lack a replaceable wick and are thus made to be disposable once the wick is burned.

Floating electronic lights are also known such as that described in U.S. Patent Appl. No. 2005/0141214 to Fotherby (publ. June 2005), which discusses a flower-shaped floating candle having an electronic light. However, Fotherby does not contemplate using a non-electric light source, and also fails to contemplate a removable portion containing the light source.

Fotherby and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Although it is known to have candle assemblies with removable wicks (e.g., U.S. Pat. No. 7,637,737 to Furner), such assemblies have an unnatural appearance and fail to be composed of wax to resemble a wax sculpture.

Thus, there is still a need for a light emitting system configured to resemble a wax sculpture and having a replaceable light emitter.

### SUMMARY OF THE INVENTION

The inventive subject matter provides apparatus, systems and methods in which a light emitting system comprises a base portion at least partially composed of wax, and a removable portion with a light emitter. As used herein, the term “wax” means an oily, water-resistant substance, normally having long-chains of hydrocarbons, alcohols or esters, although the wax need not be burnable.

The base portion can advantageously include an aperture sized and dimensioned to receive the removable portion, and can also include a coupling configured to receive the removable portion, and it is especially preferred that the coupling allows for removal of the removable portion from the base portion. In some contemplated embodiments, the base portion and the removable portion can each have an at least partially threaded surface such that the removable portion can be threaded and thereby secured to the base portion. However, the base and removable portions can have any commercially suitable couplings.

Preferred light emitting systems are configured to resemble one or more items in nature including, for example, flowers, lily pads, and other plant life, frogs, turtles and other reptiles or animals, butterflies and other insects, and combination(s) thereof.

Preferred light emitting systems are configured such that they can float in a body of water. As used herein, the term “float” means that at least 10% of the candle's surface, and preferably an average of 30%, remains above a surface of the water. It is contemplated that the specific percentage of the light emitting system above the water's surface can vary depending on the liquid's properties and the candle's buoyancy.

The light emitters can comprise light emitting diodes (“LEDs”) or other commercially suitable electronic light emitters or combination(s) thereof. Additionally or alternatively, the light emitters can comprise non-electric light sources, such as a combustible wick or a candle.

Those skilled in the art will recognize that a variety of electronic devices may be included in the light emitting system, including, for example, speakers, microphones, sensors, controllers, video screens, and so forth.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1A-1B illustrate a top view of an embodiment of a base portion and a removable portion, respectively.

FIG. 2 illustrates a top view of another embodiment of a light emitting system resembling a flower.

FIG. 3 illustrates a top view of a light emitting system resembling a butterfly.

FIG. 4 is a cross-sectional view of another embodiment of a removable portion having a wick.

FIG. 5 is a cross-sectional view of yet another embodiment of a removable portion having a candle.

FIG. 6-7 are cross-sectional views of two additional embodiments of a removable portion.

### DESCRIPTION OF THE INVENTION

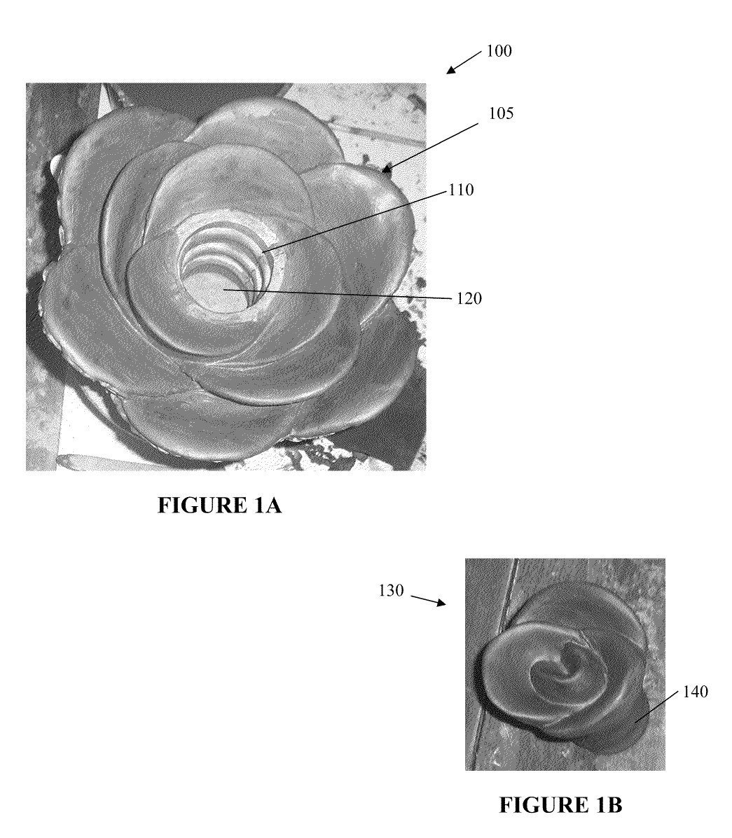

In FIGS. 1A-1B, an embodiment of a light emitting system 100 is shown having a base portion 105 that resembles a flower, although it is contemplated that the base portion 105 could resemble other items in nature or have any other commercially viable shape. The base portion 105 can include an aperture 120 that has internal threads 110 configured to mate with reciprocating threads on a removable portion 130 shown in FIG. 1B. Alternatively or additionally, the base portion 105 and/or the removable portion 130 can have any commercially suitable coupling(s) including, for example, friction fit, keys and slots and other mechanical fasteners, glue and other adhesives, magnets, and any combination(s) thereof.

The removable portion 130 preferably resembles the top of a flower and includes external threads 140 configured to mate with the internal threads 110 of the base portion 105. However, one skilled in the art would choose a coupling for the removable portion 130 that is suitable to mate with a corresponding coupling of the base portion 105. Both removable portion 130 and base portion 105 can be configured to receive one or more light emitters and various electrical components.

It is contemplated that the removable portion 130 and the light emitters (not shown) can be positioned anywhere on the light emitting system 100, and at least one light emitter is preferably placed such that the light emitter is above the water's surface when the candle is floating in the water. However, it is also contemplated that one or more light emitters can be positioned such that the light emitter is below the water's surface. This can be advantageous as the light emitting system 100 can be used to light the water in addition to, or alternatively to, the surrounding environment. In other contemplated embodiments, one or more light emitters can be disposed internally to the light emitting system 100. In such embodiments, it is preferred that the light emitting system 100 have an at least partially translucent or transparent exterior, such that the system 100 can create a glowing effect, for example.

Base portion 105 and removable portion 130 can each be made of any commercially suitable and preferably water resistant material(s) including, for example, wax, wood, plastic, metal, and any combination(s) thereof. Preferably, the base portion 105 and removable portion 130 are made substantially of wax, which facilitates the resemblance of a sculpture. In this manner, the light emitting system 100 can have a uniform appearance, which preferably resembles an item of nature. Alternatively, the base portion 105 could be composed of a different material or materials than the removable portion 130.

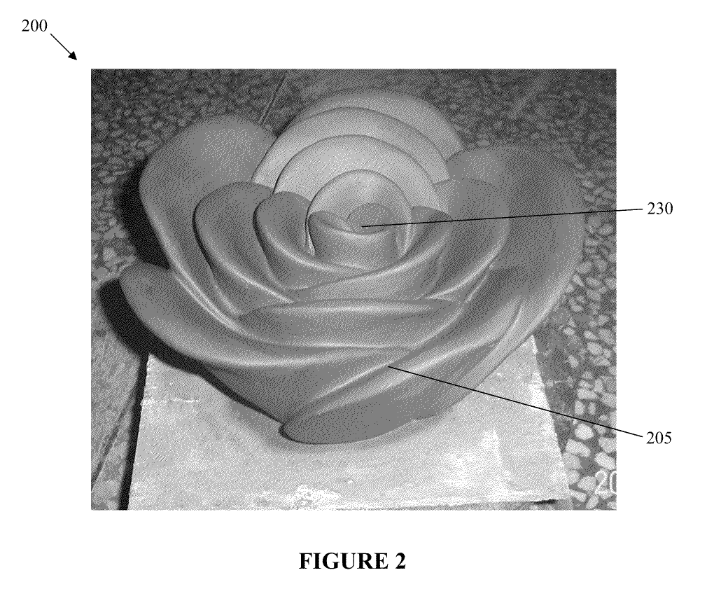

FIG. 2 shows light emitting system 200 having a base portion 205 and a removable portion 230 coupled to the base portion 205. Preferably, when removable portion 230 is coupled to base portion 205, the threads or other commercially suitable couplings are not readily noticeable.

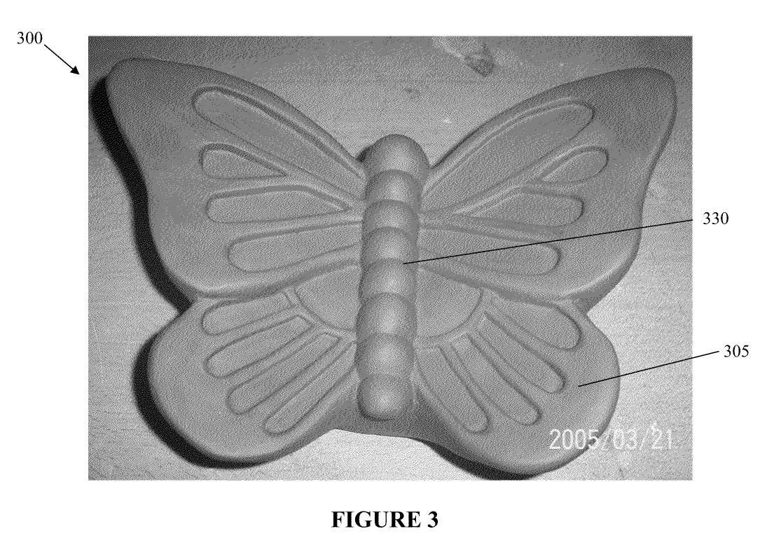

FIG. 3 illustrates another embodiment of a light emitting system 300, in which a base portion 305 resembles a butterfly and includes removable portion 330.

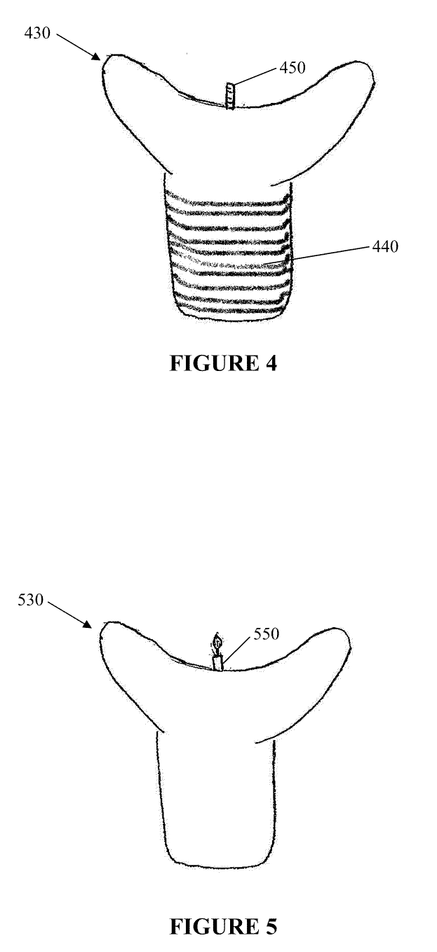

FIG. 4 is a cross section of a removable portion 430 configured to be received in a light emitting system (not shown). In this embodiment, the removable portion 430 can include a wick 450 disposed within the removable portion 430, although other commercially suitable light emitters could be used including electrically operated emitters. Preferably, removable portion 430 can be composed of a combustible wax, which is thereby burned as wick 450 burns until the majority of the removable portion 430 is consumed. In this manner, once a majority of wick 450 is consumed, the removable portion 430 may be removed from a base portion (shown in FIG. 1A) and replaced.

In FIG. 5, a removable portion 530 is shown having a candle 530. The candle 550 may be permanently or removable disposed within removable portion 530. Additionally, candle 550 may be entirely disposed within removable portion 530. It is contemplated that candle 550 could comprise an electrical candle or a combustible candle. When the candle 550 is a combustible candle or wick, removable portion 530 is preferably made of a combustible wax that emits a desirable odor or fragrance.

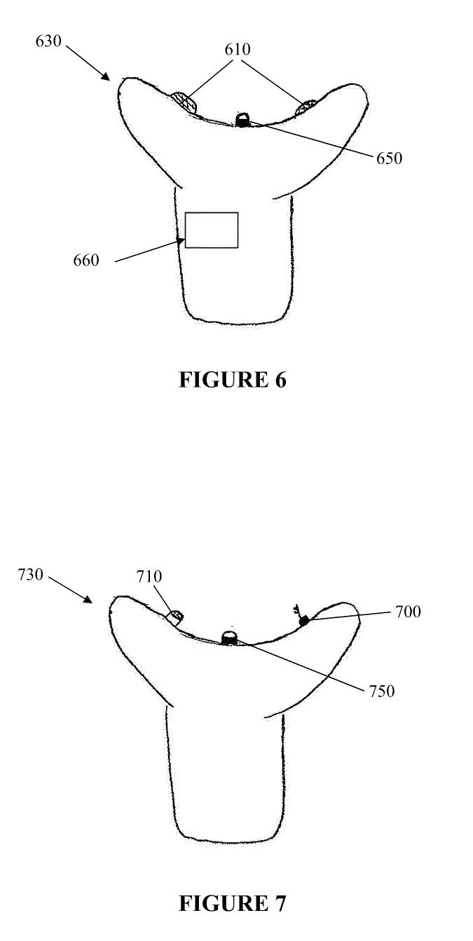

FIG. 6 illustrates a removable portion 630 having a light emitter comprising a light emitting diode 650 (“LED”). LED 650 can be easily changed by replacing the removable portion 630. In some contemplated embodiments, removable portion 630 can include one or more audio emitters 610 that can be mounted within or outside of the removable portion 630. Alternatively, audio emitter could be mounted within or outside of the base portion (not shown).

Preferably, audio emitter 610 is configured such that submersion in water will not cause the audio emitter 610 to malfunction. In this manner, the audio emitter 610 preferably has a resistance to water up to 5 feet, preferably 10 feet, and more preferably, 20 feet. This advantageously allows the audio emitter 610, and a light emitting system to which the emitter 610 is coupled, to be partially or fully submerged in a body of water such as a pool, while reducing the likelihood that the audio emitter 610 will be damaged from contact with the surrounding liquid.

Removable portion 630 may also include an additional light emitter 650, allowing for a variety of colors and configuration of light emitters 650. Preferably, removable portion 630 includes at least three, and more preferably, at least five light emitters 650. Additionally, a base portion (not shown) may also contain light emitters. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The removable portion 630, or alternatively, a light emitting system, can have a battery compartment 660 configured to hold one or more batteries (not shown). In some contemplated embodiments, the battery compartment 660 can have a single rechargeable battery that is charged via a power adapter that is pluggable into a line voltage. However, it is also contemplated that the battery compartment 660 could be configured to receive one or more disposable batteries, which might or might not be rechargeable. In other contemplated embodiments, the removable portion 630 or a light emitting system could include one or more photovoltaic cells (not shown) coupled to a battery or other power storage device to generate power using light from the sun. In such embodiments, a battery could preferably store enough energy from the sunlight on a sunny day to power the LED 650 and other electrical components for two or more hours.

FIG. 7 illustrates another embodiment of a removable portion 730 having a wireless receiver 700 and microphone 710. Receiver 710 may be configured to receive instructions wirelessly. Such instructions can advantageously by a control unit (not shown) to operate components of a light emitting system including, for example, an light emitter 750 and audio emitter. Thus, for example, a user could utilize a remote control or other device to change the volume of sound outputted by an audio emitter, to change a song played through an audio emitter, to reduce or increase the brightness of the light emitted, to alter the color of the light emitted, or to turn the light emitter 750 on or off. The control unit can include one or more processors and related circuitry that is coupled to at least one of audio and light emitters 750 such that they can be controlled by the control unit. The removable portion 730, or alternatively, the base portion of a light emitting system, can also have a storage device (not shown) capable of storing instructions, music or other audio files, software to control the lights with the music, and so forth.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A light emitting system configured to float in a liquid, comprising:
a removable portion having a light emitter; and
a base portion comprising at least some wax, and having a coupling that receives the removable portion.

2. The light emitting system of claim 1, wherein the base portion resembles a flower.

3. The light emitting system of claim 2, wherein the removable portion resembles a portion of the flower.

4. The light emitting system of claim 1, wherein the coupling has an internal screw thread, and the removable portion has an external screw thread that mates with the internal screw thread.

5. The light emitting system of claim 1, wherein the coupling comprises a through hole.

6. The light emitting system of claim 1, wherein the light emitter comprises a wick.

7. The light emitting system of claim 1, wherein the light emitter comprises a candle.

8. The light emitting system of claim 1, wherein the light emitter comprises an electronic candle.

9. The light emitting system of claim 1, wherein the light emitter comprises a light emitting diode.

10. The light emitting system of claim 1, wherein the base portion includes a wireless signal receiver.

11. The light emitting system of claim 1, wherein the base portion includes a microphone.

12. The light emitting system of claim 1, wherein the base portion includes a speaker.
